(19) United States
(12) Patent Application Publication
(10) Pub. No.: US 2013/0157376 A1
(43) Pub. Date: Jun. 20, 2013

(54) Thermal Cycler Calibration Device and Related Methods

(71) Applicant: Lyle Marion Nay, Park City, UT (US)

(72) Inventor: Lyle Marion Nay, Park City, UT (US)

(73) Assignee: Idaho Technology, Inc., Salt Lake City, UT (US)

(21) Appl. No.: 13/330,790

(22) Filed: Dec. 20, 2011

(51) Int. Cl. G01N 25/04; B01L 3/00; G06F 19/00; G01N 21/64

(52) U.S. Cl. 436/94; 422/552; 702/99

(57) ABSTRACT

Methods, devices, and systems are provided for calibrating heat sources of thermal cyclers.

### BACKGROUND OF THE INVENTION

Thermal cyclers are known in the art. Thermal cyclers can be field calibrated by using software to adjust well-to-well variation in measured temperature. Hardware calibration often requires a skilled service technician.

The present disclosure relates generally to a method for calibrating an apparatus for thermal cycling. Certain embodiments relate more specifically to a container that fits within a thermal cycling apparatus, which is configured to provide information related to the functional, experimental, or actual parameters of the thermal cycling apparatus into which the container is placed, in order to determine when apparatus calibration is required or recommended or to calibrate the apparatus manually or via software or automation.

### SUMMARY OF THE INVENTION

Thus, in one embodiment a method for calibrating a thermal cycling apparatus having at least one heat source is provided, the method comprising the steps of providing a container comprising at least one sample vessel, wherein vessel comprises a calibration mixture comprising nucleic acids having at least one nucleic acid melting domain, the melting domain having a true temperature, and a reagent that produces a signal to differentiate between single-stranded and double-stranded nucleic acids, introducing the container into the thermal cycling apparatus, heating the contents of the container, monitoring the reagent to calculate a measured melting temperature, and adjusting the heat source to correct discrepancies between the true melting temperature and the measured melting temperature of melting domains. In one illustrative embodiment, the reagent is a dsDNA binding dye, while in another illustrative embodiment, the reagent is a fluorescent dye that is bound to one of the nucleic acids. Optionally, the calibration mixture comprises a second melting domain, the second melting domain having a true temperature that is different from the true temperature of the melting domain, and both melting domains are used in the adjusting step, wherein the melting domain is a low temperature melting domain, the second melting domain is a high temperature melting domain, and the adjustment is an adjustment across temperatures using a LowCalibrationTemperature point and HighCalibrationTemperature point, wherein the two points are calculated as follows:

LowCalibrationTemperature=(PreviousLowCalibrationTemperature*A)+B

HighCalibrationTemperature=(PreviousHighCalibrationTemperature*A)+B

where A and B are:
A=(TrueHighTM−TrueLowTM)/(MeasuredHighTM−MeasuredLowTM)
B=((TrueLowTM*MeasuredHighTM)−(TrueHighTM*MeasuredLowTM))/(MeasuredHighTM−MeasuredLowTM), and

where PreviousLowCalibrationTemperature and PreviousHighCalibrationTemperature were determined in a previous round of calibration. Optionally, the adjustment across temperatures is a linear adjustment across temperatures, and a separate adjustment is made for each of a plurality of heat sources.

In another aspect of the invention, a device for use in calibrating a thermal cycling apparatus is provided, the device comprising a container comprising a plurality of sample vessels, each sample vessel comprising a calibration mixture comprising nucleic acids having at least one nucleic acid melting domain, the melting domain having a true temperature, and a reagent that produces a signal to differentiate between single-stranded and double-stranded nucleic acids and configured to generate a measured temperature for the melting domain, wherein the calibration mixture does not contain sufficient components for amplification and the sample vessel is provided sealed to prevent addition of components for amplification

In yet another aspect of the invention, a method for calibrating a thermal cycling apparatus having at least one heat source is provided, the method comprising the steps of providing a container comprising at least one sample vessel, wherein vessel comprises a calibration mixture comprising temperature-indicating reagent that provides a measurable signal a temperature, the reagent having a true temperature, introducing the container into the thermal cycling apparatus, heating the contents of the container, monitoring the reagent to calculate a measured temperature, and adjusting the heat source to correct discrepancies between the true temperature and the measured temperature.

In yet another aspect of the invention a system for calibration is provided comprising a container comprising at least one sample vessel, wherein vessel comprises a calibration mixture comprising nucleic acids having at least one nucleic acid melting domain, the melting domain having a true temperature, and a reagent that is configured to produce a measured melting temperature, a thermal cycler system comprising at least one heat source, and computing device configured to calculate desired adjustment of heat output from the heat source using the true temperature and the measured temperature.

Additional features of the present invention will become apparent to those skilled in the art upon consideration of the following detailed description of preferred embodiments exemplifying the best mode of carrying out the invention as presently perceived.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a perspective view of a sample plate above a thermal cycler apparatus.

FIG. 2 is a perspective view of the sample plate on a thermal cycler apparatus with a partial cut-away view.

FIG. 3 is a cross-sectional view of the sample plate on the thermal cycler apparatus taken along cutting line 3-3 in FIG. 2.

FIG. 4 is an isolated sectional view taken along cutting line 4-4 in FIG. 2 of the thermal cycler apparatus.

FIG. 5 is an exploded perspective of the sections shown in FIG. 4 of the sample plate on the thermal cycler apparatus.

FIG. 6 is a cross-sectional side view taken along cutting line 6-6 in FIG. 4 of the embodiment of the thermal cycler apparatus and sample plate that are shown in FIGS. 1-5.

FIG. 7 is a cross-sectional side view of a different embodiment of thermal cycler apparatus.

FIG. 8A is a cross-sectional side view of another embodiment of a thermal cycler apparatus.

FIG. 8B is a perspective view of the embodiment of a thermal cycler apparatus shown in FIG. 8A with a cross-sectional view to show a clamp.

FIG. 9 is a cross-sectional side view of an additional embodiment of a thermal cycler apparatus.

FIG. 10 is a cross-sectional side view of another embodiment of a thermal cycler apparatus.

FIG. 11 is a cross-sectional side view of yet another embodiment of a thermal cycler apparatus.

FIG. 12 is a cross-sectional side view of the embodiment of the thermal cycler apparatus and sample plate shown in FIGS. 1-5 that shows the configuration of the thermal block plate.

FIG. 13 is a perspective view of the well block shown in FIG. 1.

FIG. 14 is a cross-sectional side view of the well block taken along cutting line 14-14 in FIG. 13.

FIG. 15A is a perspective view of the well block and a base plate before they are joined together.

FIG. 15B is a perspective view of the well block and a base plate after they are joined together.

FIG. 15C is a perspective view, looking at the bottom of the wells, of the well block and paired sections of the base plate after removal of portions of the base plate.

FIG. 16 is a perspective view, looking into the wells, of the well block and paired sections of the base plate after removal of portions of the base plate.

FIG. 17 is a side cross-sectional view, of the well block and paired sections of the base plate after removal of portions of the base plate.

FIG. 18 is a plan view of the paired section of the base plate on the well block as shown in FIGS. 15C-17.

FIG. 19 is a plan view of sections of the base plate that are on a plurality of wells of a well block.

FIG. 20 is a perspective view of sections of the base plate that are on a plurality of wells of a well block.

FIG. 21 is a perspective view, looking into the wells of the well block and sections of the base plate on a plurality of wells of the well block.

FIG. 22 is a side cross-sectional view, of the well block and sections of the base plate on a plurality of wells of a well block.

FIG. 23A is a perspective view of a peltier device receiving a temperature detector.

FIG. 23B is a perspective view of a temperature detector on a peltier device.

FIG. 24 is a perspective view of a peltier device on an adhesive on a heat sink.

FIG. 25 is an exploded perspective view of peltier devices on a well block, adhesive, and base plates attached to a well block.

FIG. 26 is a perspective view of a series of twenty-four peltier devices on a printed circuit and the wires that connect the devices with the printed circuit.

FIG. 27 is a perspective view of a well block on the peltier devices shown in FIG. 26 and their associated wires.

FIG. 28 is a block diagram of an automated system for nucleic acid amplification and analysis.

### DETAILED DESCRIPTION

As used herein, “nucleic acid,” “nucleotide,” “oligonucleotide,” “DNA,” and similar terms also include RNA, nucleic acid analogs, and nucleic acid substitutes, i.e. naturally occurring or synthetic analogs or substitutes having other than a phosphodiester backbone. Non-limiting examples, including the so called “peptide nucleic acids” (PNAs) and the so called “locked nucleic acids” (LNAs) are considered within the scope of this invention. Non-analogous nucleic acid substitutes are also considered within the scope of this invention.

As used herein, “base pair,” “base pairing,” and similar terms refer to the association of complementary nucleotides or nucleic acids as previously defined and are not limited to canonical Watson-Crick base pairing or association via hydrogen bonding.

As used herein, “double-stranded” refers to the base pairing of at least one pair of nucleotides and is not limited to oligonucleotides or nucleic acids of any particular length or base pairs from separate nucleic acid strands.

As used herein, “melting domain,” “nucleic acid melting domain,” and similar terms refer to portion, unit, or segment of double-stranded nucleic acid that remains in a double-stranded configuration at certain temperatures and separates or melts into single-stranded nucleic acid at other temperatures.

As used herein, “calibrator plate,” “sample plate,” “sample container,” and similar terms refer to a container comprising a plurality of sample vessels or compartments, and does not necessarily imply the presence of a sample, known or unknown, within the sample vessels, or a rigid, plate-like configuration. Non-limiting examples of illustrative configurations include 8-tube strips, 12-tube strips, 48-well plates, 96-well plates, 384-well plates, and 1536-well plates. Furthermore, use of a multi-well sample plate or a multi-tube strip herein is illustrative only. Other configurations of sample vessel-comprising containers are known in the art. Additional non-limiting embodiments of sample plate containers, including sample tubes, capillaries, and flexible pouches, are also considered within the scope of this invention.

As used herein, “sample vessel,” “sample compartment,” “sample well,” and similar terms refer to a portion or partition of a sample container that is configured to provide a barrier that limits fluid communication between adjacent portions or partitions, and does not imply the presence of a sample, known or unknown, within the sample vessel, compartment, or well. Non-limiting, illustrative examples include wells of a sample plate or tube strip and blisters formed in a flexible or non-flexible sample pouch.

As used herein, “Temperature-indicating reagents” and similar terms refer to molecules, components, chemicals, compounds, or other materials that are capable of demonstrating, suggesting, or revealing an actual, experimental, or approximate temperature and may include nucleic acids illustratively with associated indicators such as dyes, nucleic acid binding dyes, covalently-bound dyes, probes, fluorescent probes, and other temperature indicators such as fluorescent moieties, fluorescent units, temperature-sensitive liquid crystals, or other thermochromic, temperature-sensitive, or temperature-responsive substances.

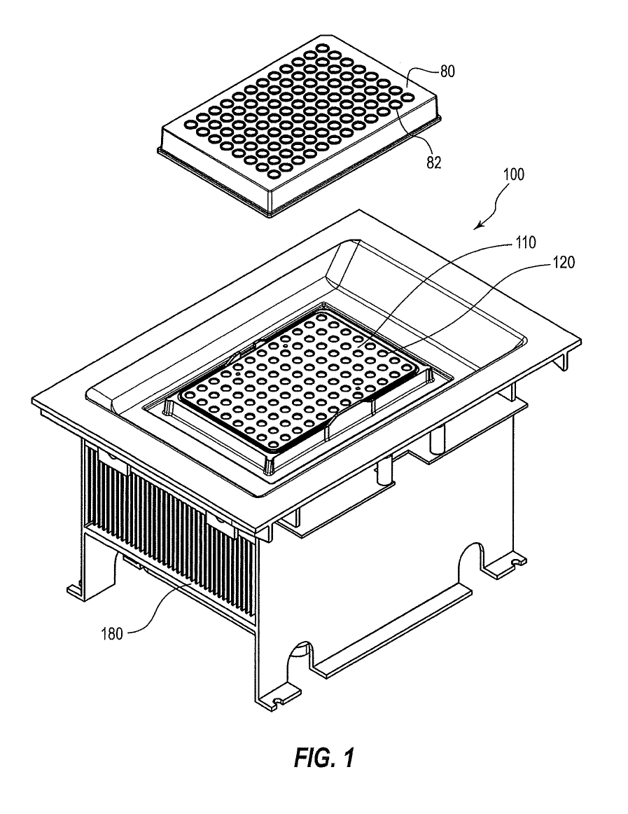

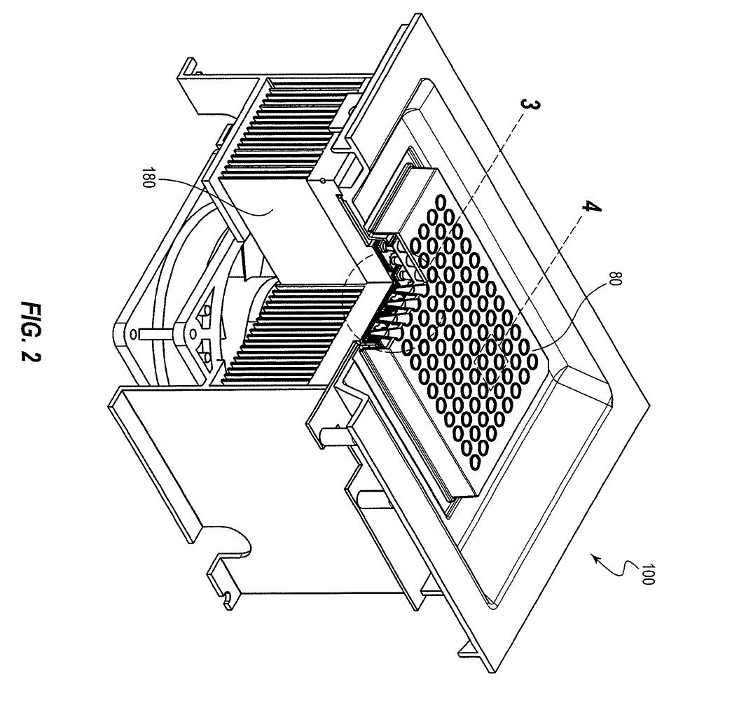

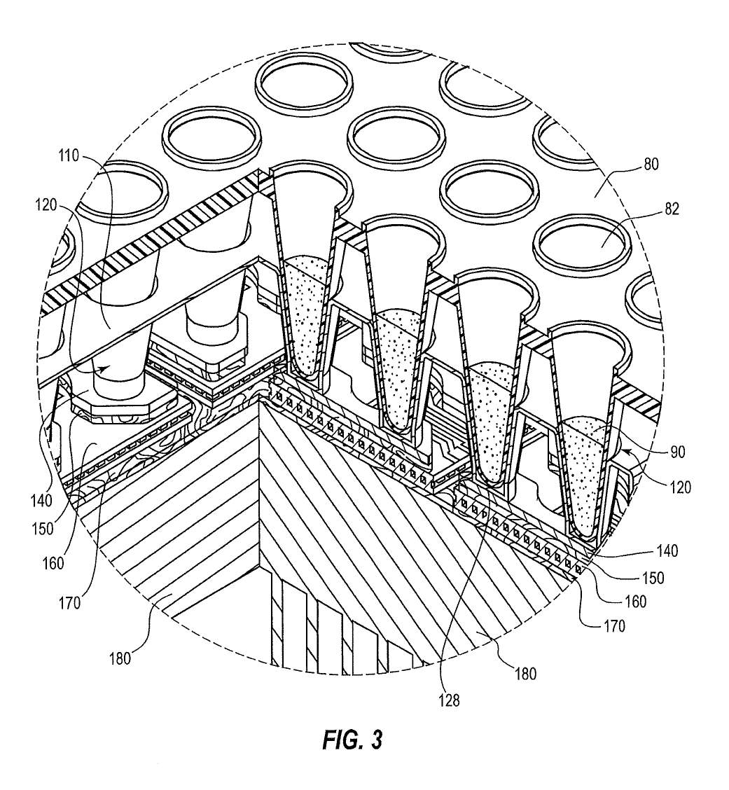

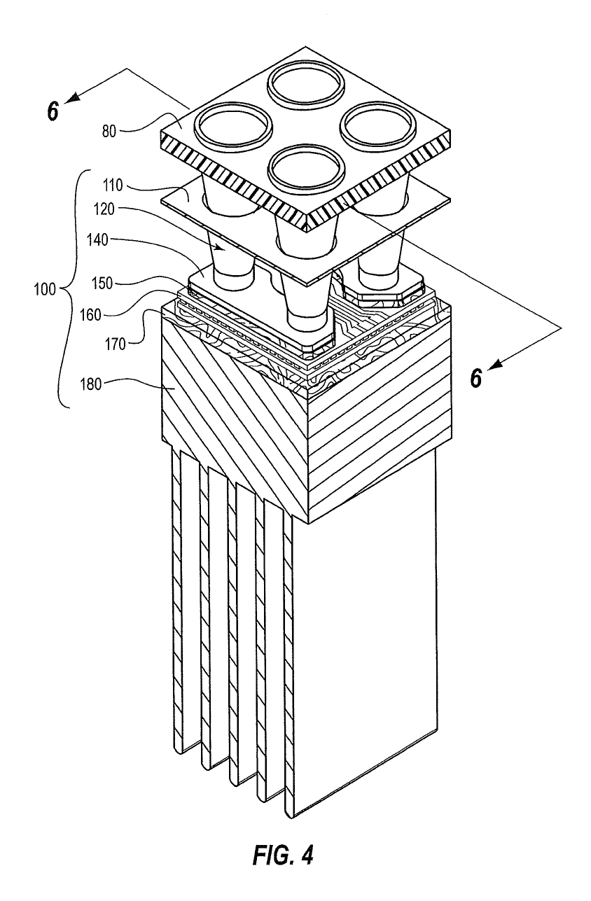

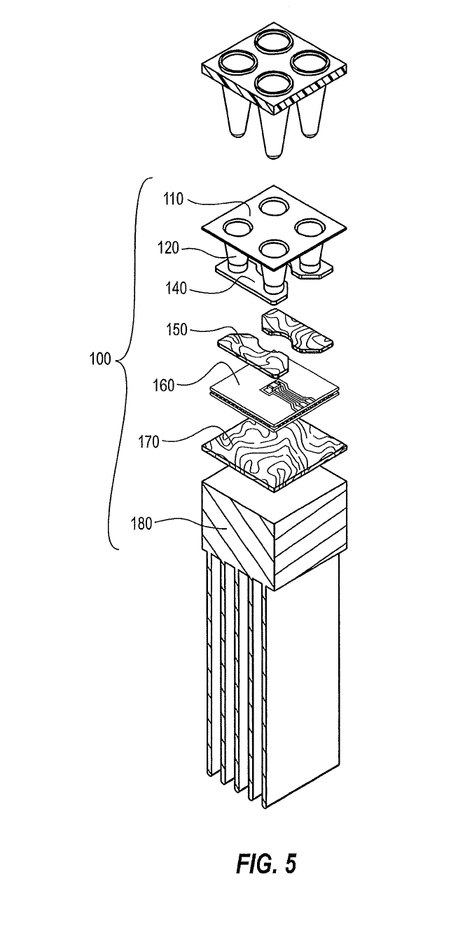

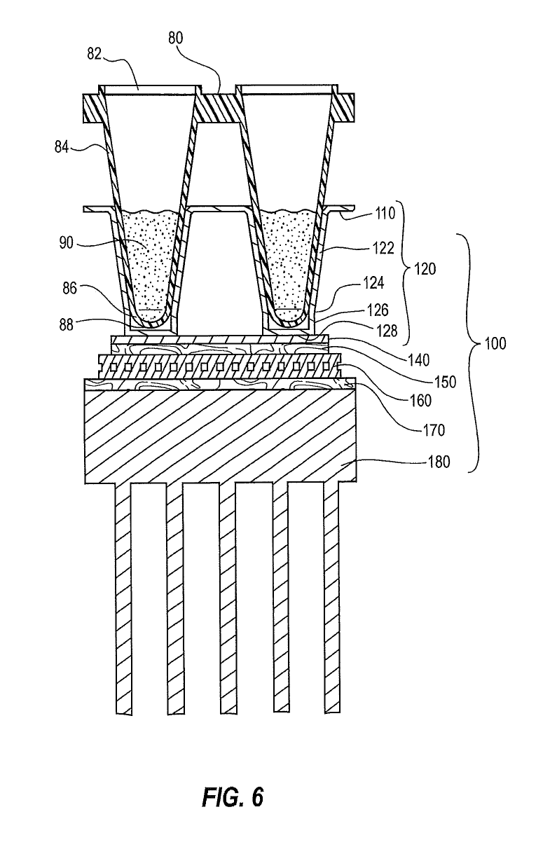

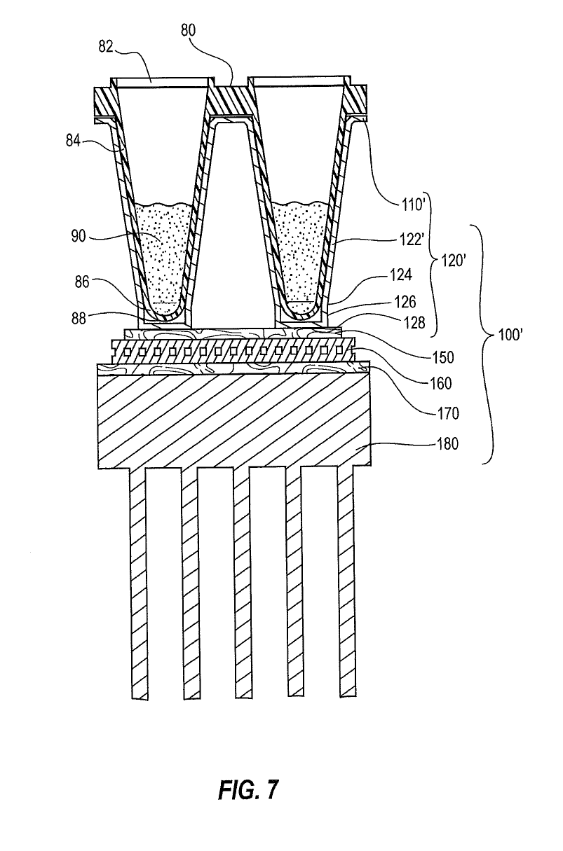

FIG. 1 shows a sample or calibrator plate 80 with sample wells 82 ready to be positioned on a well block 110 of a thermal cycler apparatus 100 such that each sample well 82 is positioned in a well 120 of well block 110. FIG. 2 shows the same components after sample or calibrator plate 80 is positioned on thermal block plate 110. The configuration of thermal cycler apparatus 100 can be appreciated by studying FIGS. 3-6. FIG. 3 is an enlarged view of the cut-away provided in FIG. 2. FIGS. 4-6 provided isolated sectional views taken along cutting line 4-4 in FIG. 2 of the sample or calibrator plate on the thermal block plate. FIG. 3 and FIG. 6 show a sample 90, illustratively for PCR, in each sample well 82 and the components of the embodiment of the thermal cycler apparatus shown at 100 including a well block 110, a base plate 140, a layer of adhesive 150, a peltier device 160, another layer of adhesive 170 and a heat sink 180. As shown in FIGS. 3-6, well block 110 extends roughly half way up side wall 84 of sample well 82. However, this is exemplary only and it is understood that other well block heights are within the scope of this invention, such as the tall well block 110′ shown in FIG. 7. The exploded perspective of the components shown in FIG. 5 provides the most insightful view as it can be seen that there is a pair of base plates 140 for each 4-well zone, and each pair spans between two adjacent wells. It can also be seen in FIG. 5 that the layer of adhesive 150 provides an interface with peltier device 160. Additionally, it can be seen that peltier device 160 is thermally coupled to the pair of base plates 140 via the layer of adhesive 150.

More detail regarding the plurality of wells 120 of well block 110 can be seen in FIG. 6. Well 120 is shown having an upper conical sidewall 122, a transitional sidewall 124, a lower cylindrical sidewall 126 and a bottom 128 that is flat and extends between lower cylindrical sidewall 126. Flat bottom 128 rests on base plate 140, which rests on adhesive 150 to be thermally coupled to peltier plate 160. FIG. 6 also shows more details about the configuration of sample well 82 including sidewall 84, rounded bottom-section 86 of well 82 and the round apex 88.

The layers of adhesive 150 and 170 may be the same material. The adhesive is ductile and flexible, has relatively high thermal conductivity and low viscosity. Illustratively, the adhesive enhances the uniformity of heat transfer between peltier 160 and wells 120. In one embodiment, the adhesive permits apparatus 100 to be assembled without the use of conventional clamps used to clamp a well block to a heat sink. When an adhesive is used in an embodiments such as apparatus 100, the adhesive is capable of retaining the peltier device 160 adjacent to the structure contacted by the adhesive such as the wells 120 of well block 110 and/or heat sink 180 even when apparatus 100 is turned upside down without clamping well block 110 to heat sink 180.

Various embodiments of a suitable adhesive are capable of cycling between a temperature at least as high as 95° C. and at least as low as 60° C. at least about 5,000 times, at least about 10,000 times, at least about 100,000 times, or at least about 200,000 times and still be capable of retaining peltier device 160. Various embodiments of a suitable adhesive may have an elongation, as defined below in the Examples, of at least about 15%, 20%, 22%, 35%, 40%, 50%, 55%, 60%, 70%, 90%, 110%, 120%, 180%, 200%, 400% or ranges within combinations of these values such as about 15% to about 1,000%, about 35% to about 700%, about 70% to about 500%, or between 100% to about 200%.

Suitable adhesives may also have an unprimed adhesion lap shear of between about 1 kgf/cm² and about 75 kgf/cm², over about 10 kgf/cm², between about 10 kgf/cm² and about 45 kgf/cm². The viscosity of the adhesive may range between about 1,000 centipoise and about 200,000 centipoise, between about 10,000 centipoise and about 150,000 centipoise, between about 20,000 centipoise and about 80,000 centipoise, or between about 30,000 centipoise and about 40,000 centipoise.

Various embodiments may also have a thermal conductivity, as defined below in the Examples, of at least about 0.39, 0.40, 0.74, 0.77, 0.84, 0.85, 0.9, 0.92, 0.95, 1.1, 1.4, 1.53, 1.8, 1.9, 1.97, 2.2, 2.5 or ranges within combinations of these values such as about 0.74 to about 2.5 or about 0.9 to about 1.8. In one embodiment, the adhesive has a thermal conductivity at 25° C./77° F. of between about 0.7 Watt/meter-K and about 2.5 Watt/meter-K. In another embodiment, the adhesive has a thermal conductivity at 25° C./77° F. of between about 0.8 Watt/meter-K and about 2.0 Watt/meter-K. In one embodiment, the adhesive has a thermal conductivity at 25° C./77° F. of between about 0.9 Watt/meter-K and about 1.5 Watt/meter-K. In yet another embodiment, the adhesive has a thermal conductivity at 25° C./77° F. of over about 1.0 Watt/meter-K. In a further embodiment, the polymer has a thermal conductivity at 25° C./77° F. of about 1.1 Watt/meter-K.

Examples of suitable adhesives include thermally conductive silicone pastes, which are non-curing. Specific trade names of suitable thermally conductive silicone pastes, which are non-curing, are provided by those listed in the Examples.

The embodiment depicted in FIG. 7 of a thermal cycler apparatus at 100′ differs from apparatus 100 as apparatus 100′ does not have base plates such as base plate 140. Also, apparatus 100′ features a well block 110′ having wells 120′ with taller side walls 122′. The embodiments of the well blocks disclosed herein may each have such taller side walls instead of side walls 122 or side walls 422. Wells 120′ have flat bottoms 128 that are directly over and in contact with a layer of adhesive 150. While the configuration of apparatus 100′ provides less area for layer of adhesive 150 to bond to relative to the configuration of apparatus 100, the configuration of apparatus 100′ also permits faster heat transfer between peltier device 160 and wells 120′ as there is less mass for the heat to pass through without a base plate.

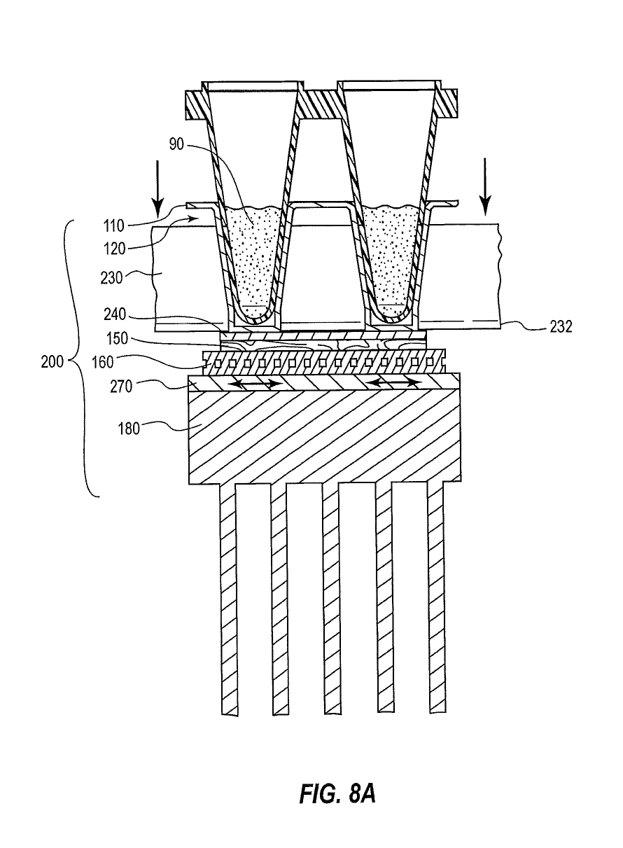

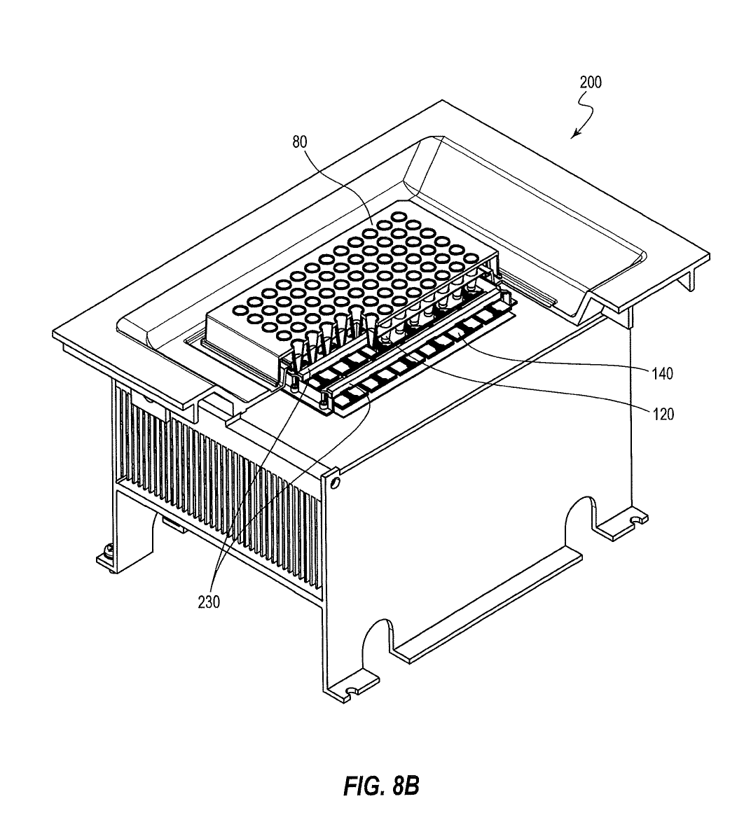

FIGS. 8A-8B depicts another embodiment of a thermal cycler apparatus at 200. Apparatus 200 features a carbon sheet or grease or other non-binding thermal interface material at 270 instead of an adhesive. Optionally, the non-binding thermal interface material 270 may also replace the layer of adhesive 150. Because carbon sheet or grease does not retain peltier device 160 adjacent to heat sink 180 when apparatus 100′ is turned upside down, it is necessary to clamp well block 110 to heat sink 180 with a clamp bar 230. Clamp bar 230 may alternatively rest on a thin compression pad or compliant layer 232 that may be formed from a suitable material such as silicone. Clamp bar 230 extends across adjacent base plates 140 and can be attached at its ends with conventional mechanisms for clamp systems to the apparatus 200. It is also possible use clamp screws that extend through the well block and into the heat sink. Various clamp bar and clamp screw embodiments are known in the art.

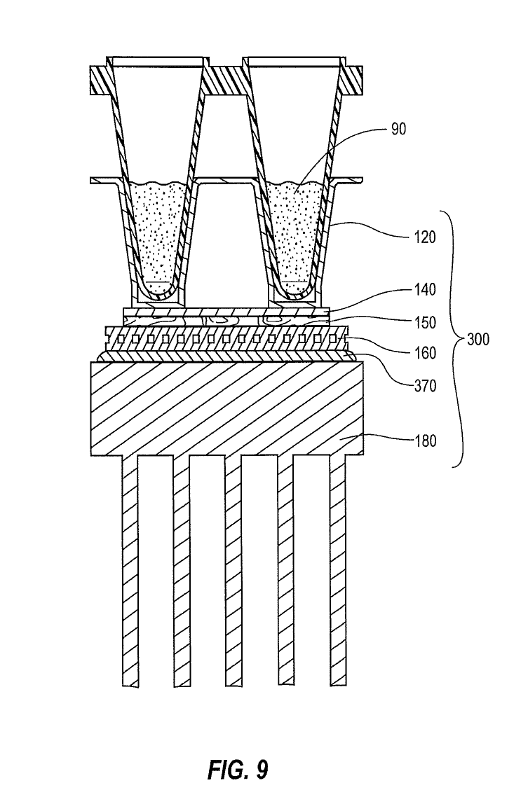

FIG. 9 depicts another embodiment of a thermal cycler apparatus at 300. Apparatus 300 features solder 370 between peltier device 160 and heat sink 180. As with the embodiments shown in FIGS. 6-7, with this configuration, it is also not necessary for well block 110 to be clamped to heat sink 180.

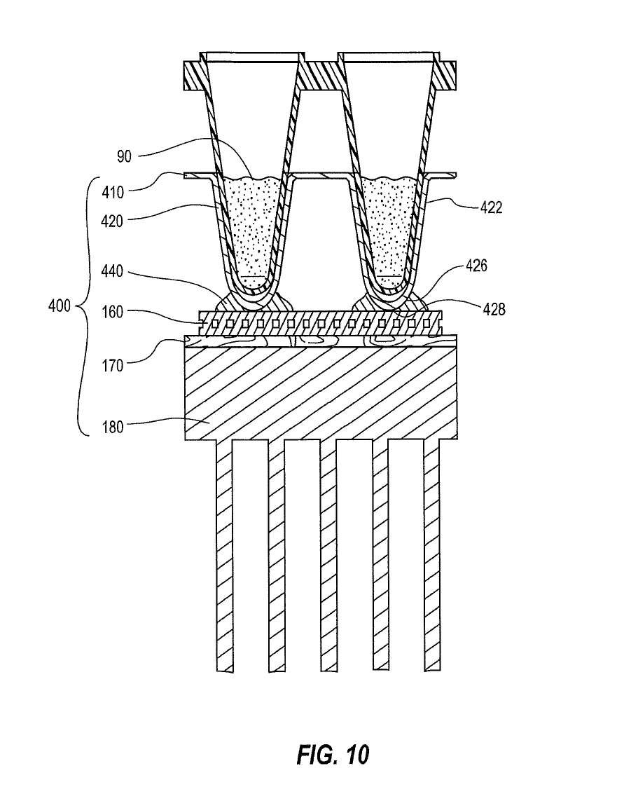

FIG. 10 depicts another embodiment of a thermal cycler apparatus at 400. Apparatus 400 features a well block 410 with wells 420 that have sidewalls 422, which transition to rounded bottoms 426 and have a rounded apex 428 instead of a flat bottom. Also, the rounded bottom of each well 420 rests in solder 440 illustratively with rounded apex 428 directly contacting peltier device 160. Wells with flat bottoms such as wells 120 can also be soldered like wells 420 directly to a peltier device, as shown in FIG. 7.

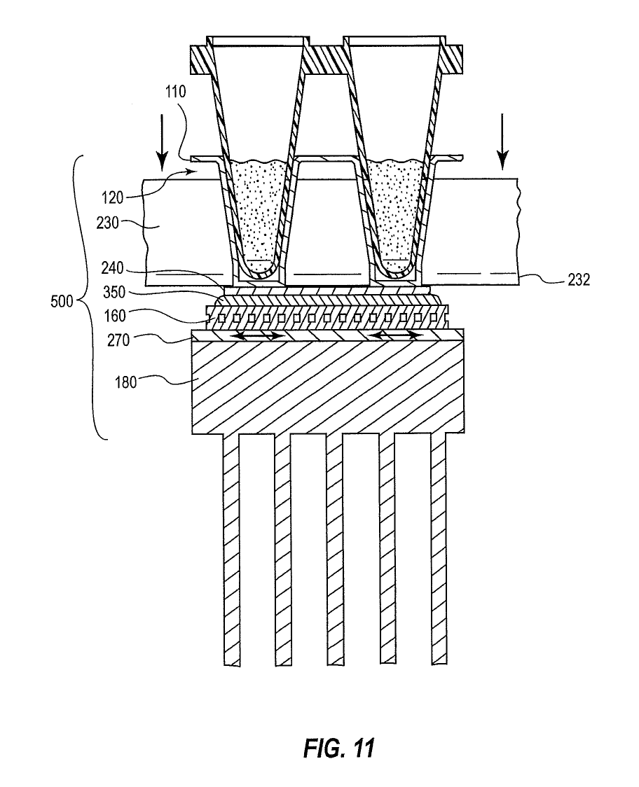

FIG. 11 depicts another embodiment of a thermal cycler apparatus at 500. Apparatus 500 features well block 110, on base plate 240, which is soldered to peltier device 160 via solder 350. Peltier device 160 rests on non-binding thermal interface material 270 so clamp bar 230 is also used with the same configuration as described above with respect to apparatus 200. In addition to the apparatuses discussed above and depicted at 100, 100′, 200, 300, 400 and 500, other combinations may also be used. For example, apparatus 500 can be modified by replacing solder 350 with adhesive 150 or with non-binding thermal interface material 270 such as carbon or grease.

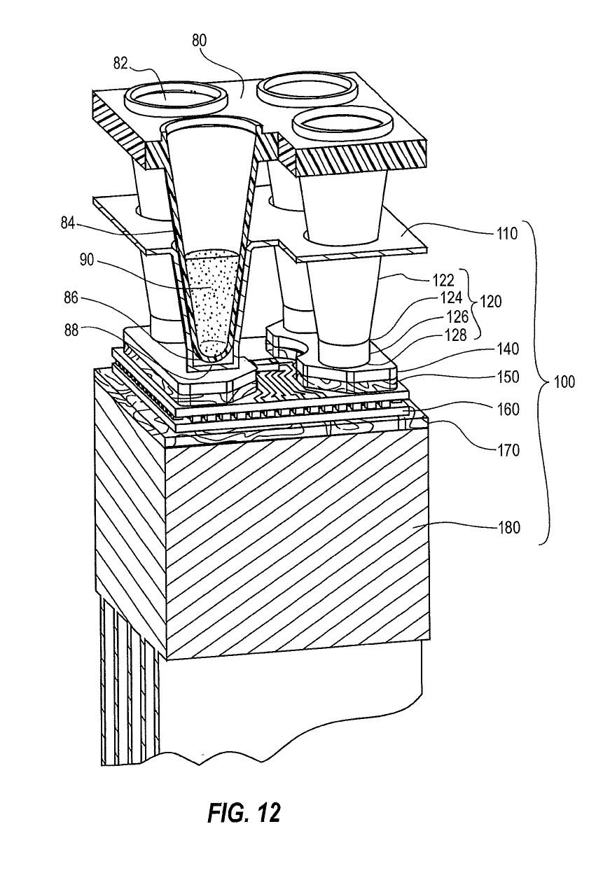

FIG. 12 corresponds with the embodiment shown in FIGS. 1-6 and shows all of the components of a single zone. Apparatus 100 has a well block 110 that comprises a plurality of 4-well zones, wherein each 4-well zone comprises a first pair of wells 120 and a second pair of wells 120, and wherein each first pair of wells 120 and each second pair of wells 120 are respectively over a first base plate and a second base plate such that one peltier device 160 provides for heat transfer for one 4-well zone. Each peltier device 160 heats or cools a pair of base plates 140 via adhesive 150 to heat or cool the sample in the four sample wells via each bottom 128 and side walls 122 of the four wells 120. Heat sink 180 is thermally connected to peltier device 160 via adhesive 170. It is understood that the 4-well zone is illustrative only, and that each zone may comprise various other numbers of wells.

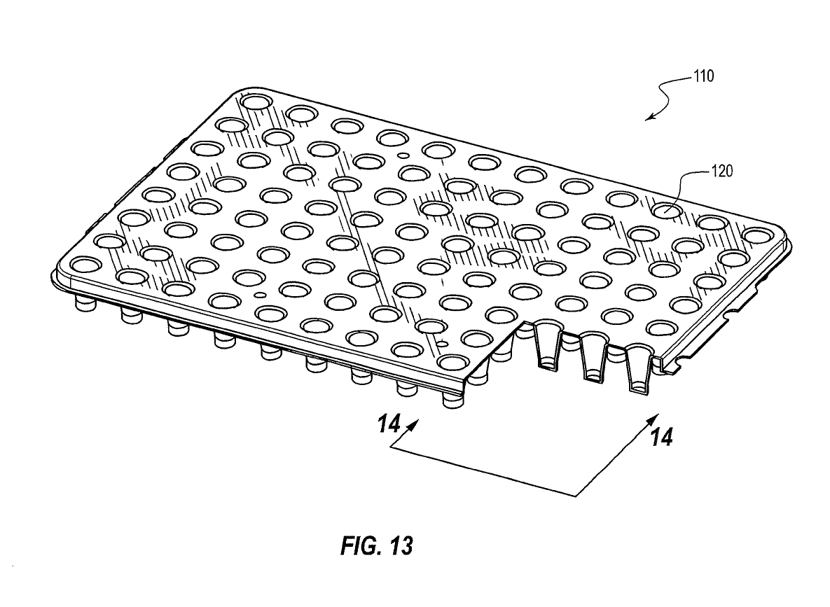

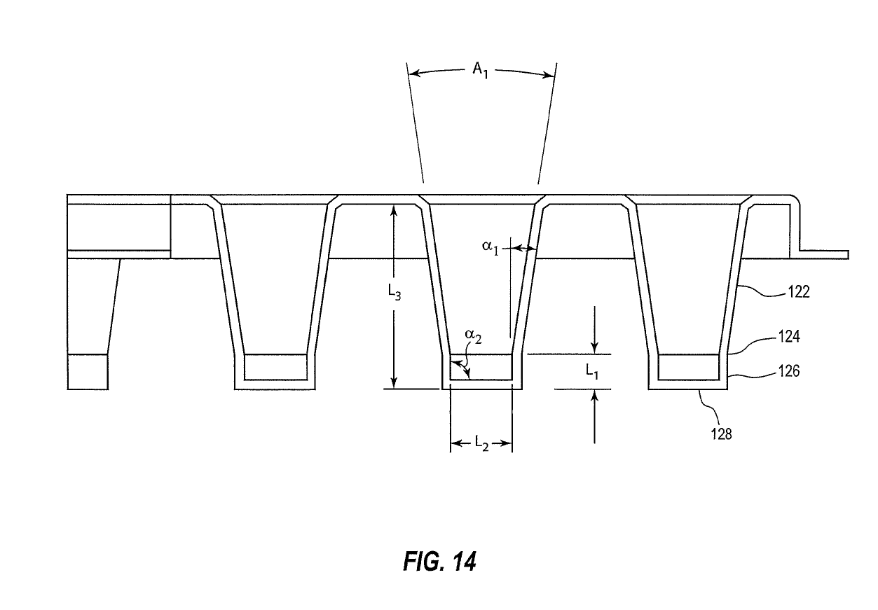

More detailed information about the configuration of well 120 can be appreciated with reference to FIGS. 12-14. FIG. 14 provides references for describing the dimensions of well 120. The length of lower cylindrical sidewall 126 is identified as L₁, the diameter of flat bottom 128 is identified as L₂, and the depth of well 120 is identified as L₃, and the angle between the upper conical sidewall 122 and a line extending from the lower cylindrical sidewall 126 is identified as α₁. The angle, α₁, between the upper conical sidewall 122 and the lower cylindrical sidewall 126 in one embodiment is about 16°, such as 16.3°, however other angles are within the scope of this invention and may approximately correspond to external dimensions of commercially available microtiter plates. The angle, α₂, between the lower cylindrical sidewall 126 and flat bottom 128 is equal to or slightly greater than 90°, such as 92°, however other angles are within the scope of this invention. While a 90° angle α₂ is contemplated, angles slightly greater than 90° may be desired, illustratively to ease removal of well block 110 from the mold used in the manufacturing process. It is understood that if angles slightly greater than 90° for α₂ are used, that cylindrical sidewall 126 will define a generally cylindrical section that is, in fact, slightly conical. Illustratively, α₂ is less than 90°+α₁, illustratively 95° degrees or less, and more illustratively, 92° or less.

An advantage of flat bottom 128 relative to prior art configurations is that the shape can be manufactured with greater uniformity, and provides additional surface area that enables heat to be transferred with greater uniformity and at a more rapid rate. However, it is understood that flat bottom 128 may have rounded edges near sidewall 126 or otherwise may not be completely flat from one side of cylindrical sidewall 126 to the other. Moreover, because lower cylindrical sidewall 126 does not interfere with insertion of the sample well 82 into well 120, the shape of the well 120 allows sample well 82 to have maximal contact with the sidewall 122 of the wells in each well block.

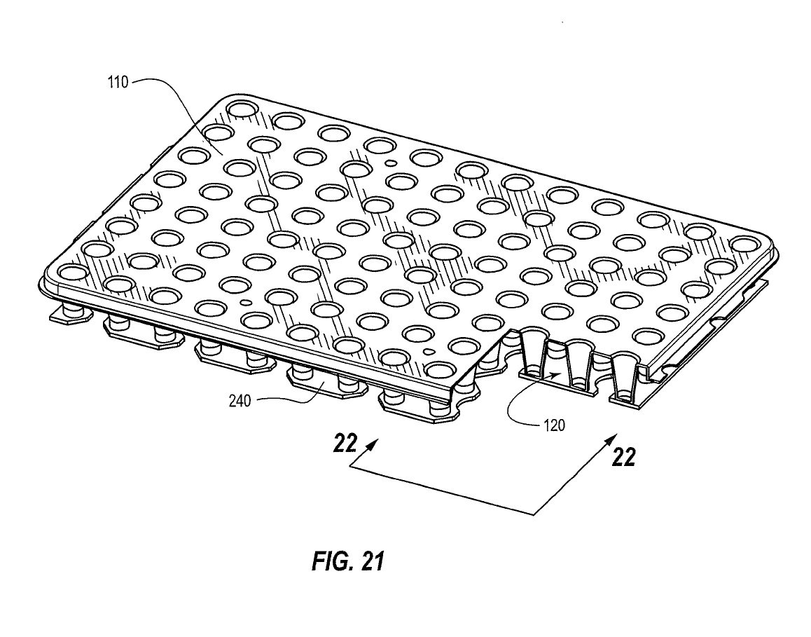

An average well 120′ of well block 110′, as shown in FIG. 7, is close to the height of sample well 82 and illustratively has a depth of about 0.5 inches-0.6 inches for a 96-well plate. Such a well block allows sample well 82 to be filled with a large sample volume and also mitigates against the effects of a heated lid that may be at a static temperature. Most embodiments illustrated in this disclosure, including in FIGS. 1-6, 8-17, 20-22, and 25, have a depth of well 120, L₃, that is shorter, illustratively only about 0.3 inches for a 96-well plate. An advantage of this configuration is a decrease in the incidence of sidewall condensation, particularly during cooling. Due to reduced well height relative to a convention well, another advantage of this configuration is a decrease in well block mass relative to prior art configuration, which increases the thermal cycling rate. It is understood that the choice of height of the wells of the well block depends on the specific application and that either configuration may be used with the various embodiments disclosed herein.

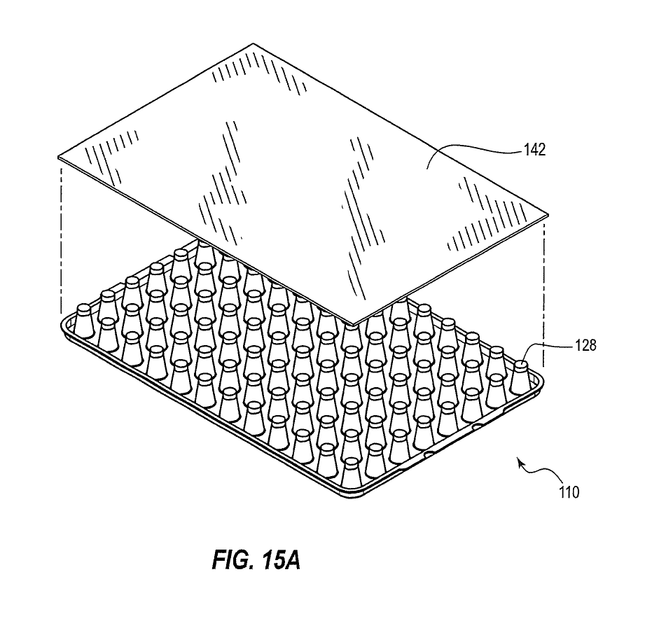

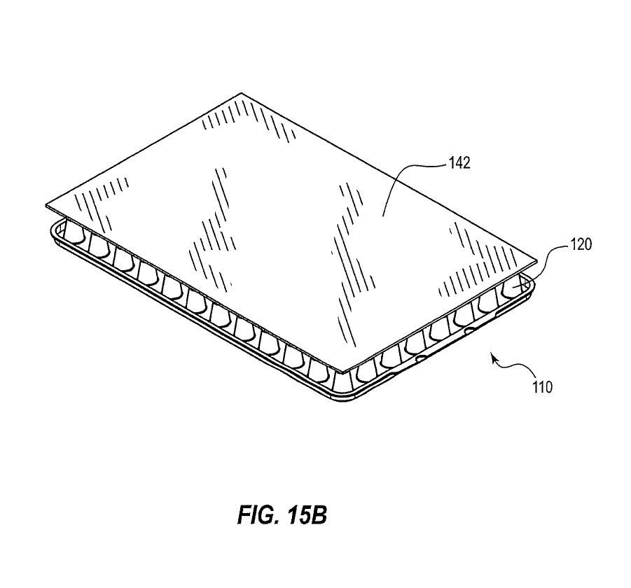

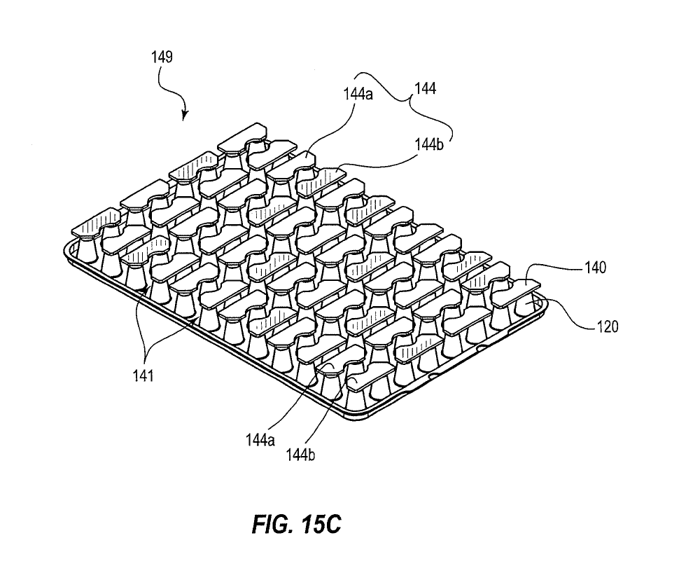

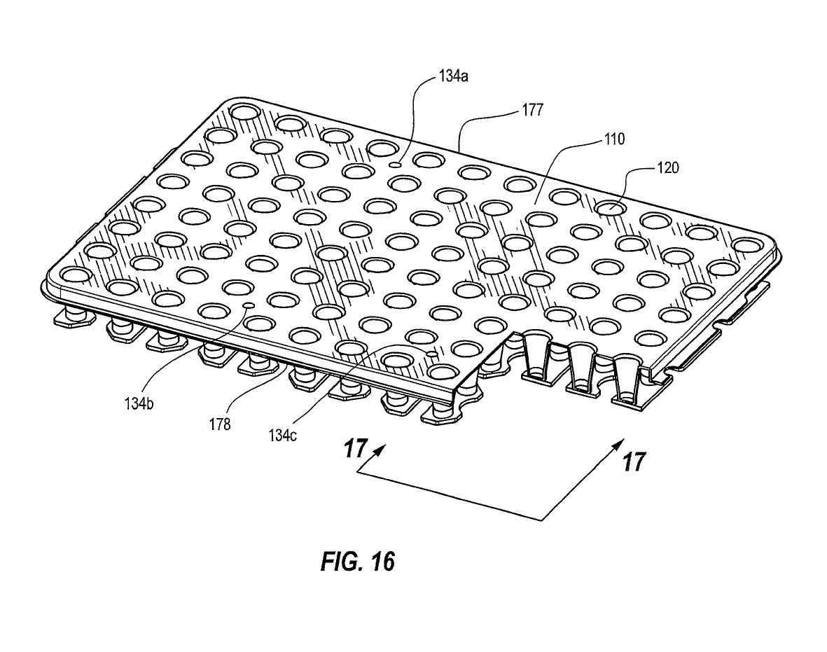

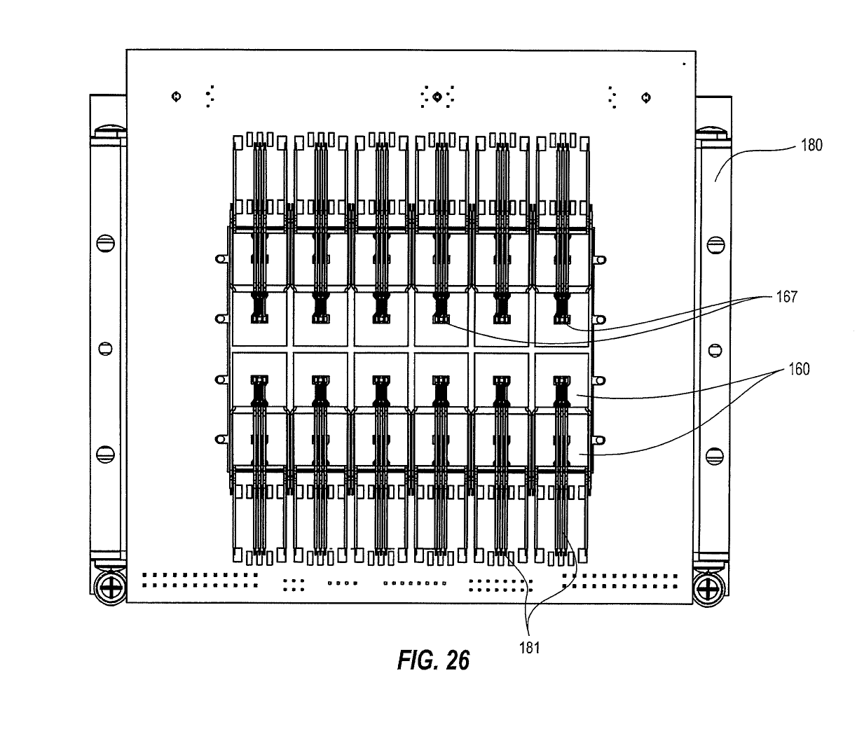

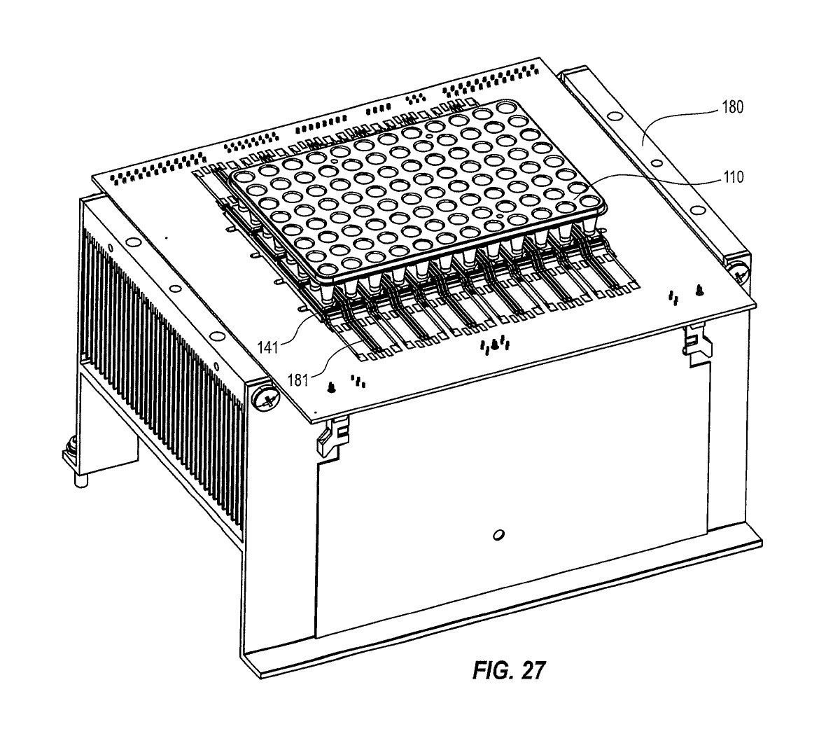

FIGS. 15A-15C depict an illustrative method of manufacturing a well block assembly 149 to yield pairs of base plates on the bottoms of wells. First a precursor base plate sheet 142 is obtained as shown in FIG. 15A and then is attached to flat bottom 128 illustratively by soldering, as illustrated in FIG. 15B. Then, portions of the precursor base plate sheet are removed to yield pairs of base plates 144a, 144b that span adjacent wells, as shown in FIG. 15C. The portions of the base plate sheet may be removed by any conventional method such as machining, punching, stamping, or dicing. Alternatively, the base sheet could be cut first and the base plates added thereto. By removing portions of precursor sheet 142, channels 141 are formed that may be used as space for wiring, illustratively to wire the peltiers 160 or temperature detectors 167, as shown in FIGS. 26-27. FIG. 16 shows another view of well block 110 with paired sections of the base plate. FIG. 17 provides the identification of the length of base plate 140, which is L₄.

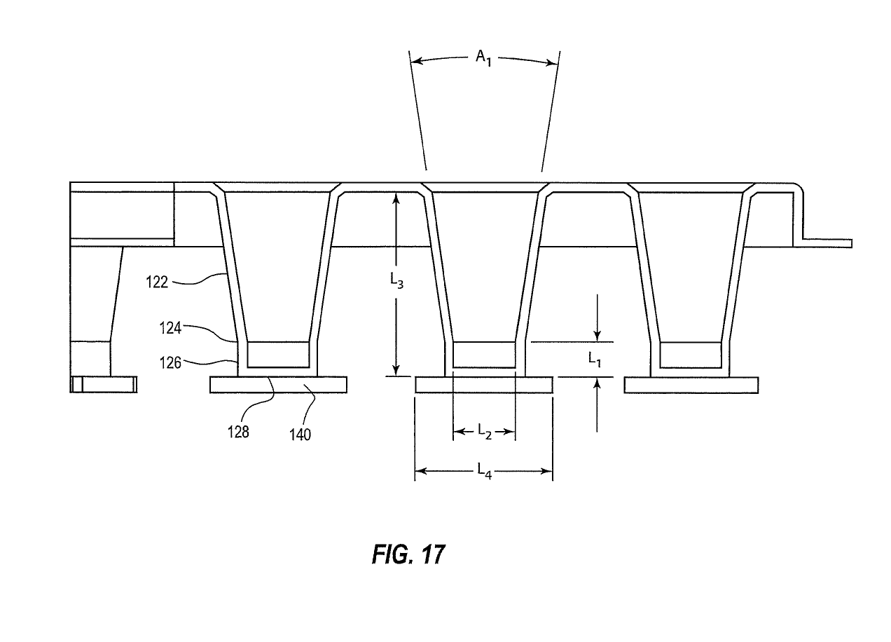

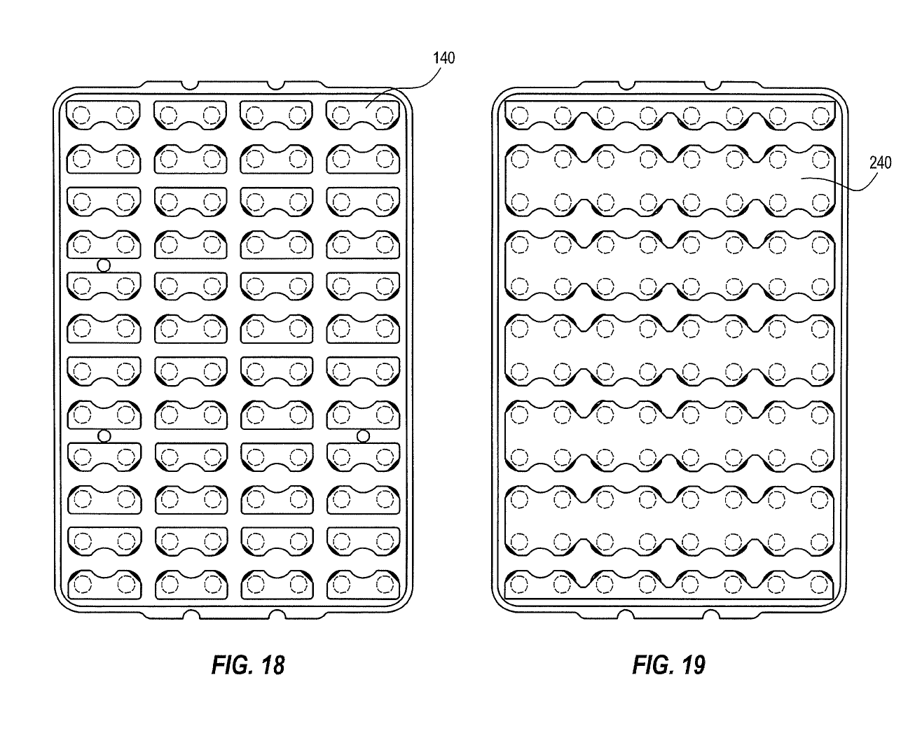

FIGS. 18 and 19 provide the same view of different embodiments. FIG. 18 corresponds with apparatus 100. FIG. 19 shows base plates 240 that connects more than four wells. Such an embodiment may result in increased uniformity, albeit with a reduction in control. Base plates 240 are also more easily used with a clamp bar such as clamp bar 230 shown in FIGS. 8A-8B and FIG. 11. A solid base plate may be acceptable in some embodiments, illustratively with recessed temperature sensors.

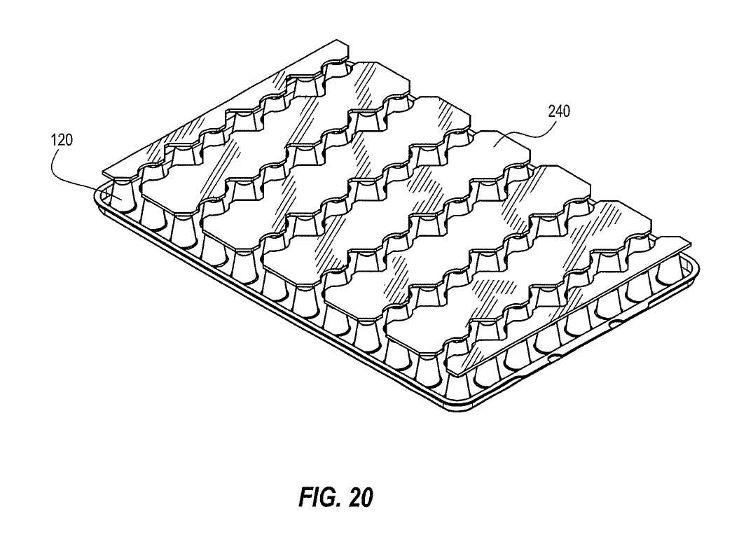

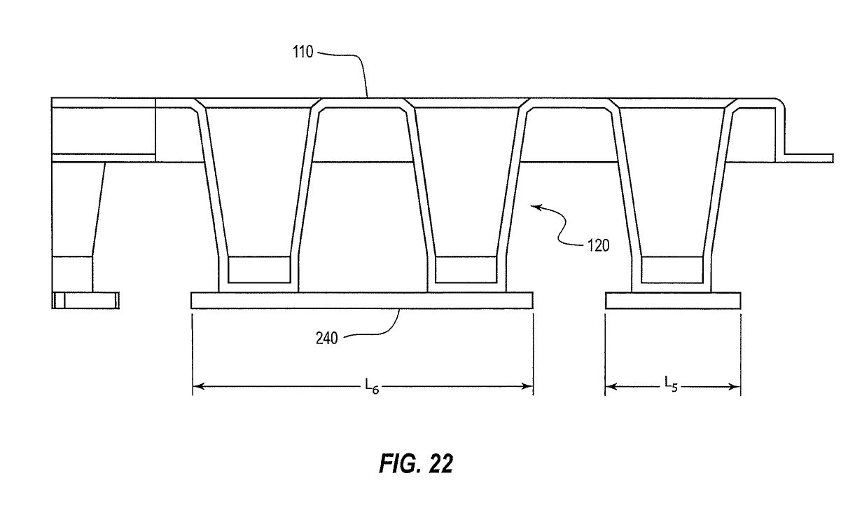

FIGS. 20-22 show the same embodiment depicted in FIG. 19 but from a different views. FIG. 22 provides the identification of the length of base plate 140′, which is L₅ when it spans wells that are at the perimeter and is L₆ when it spans wells not at the perimeter.

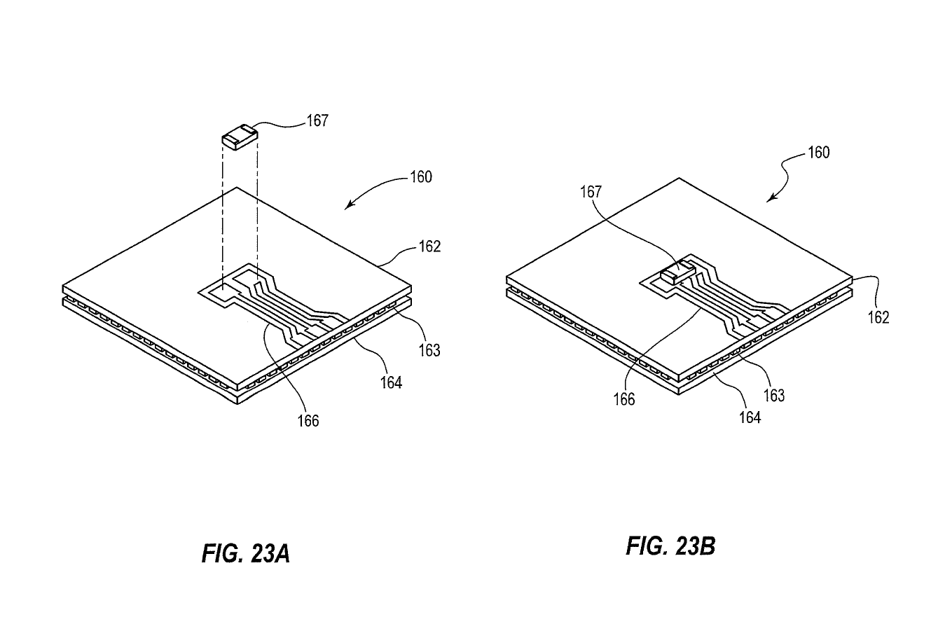

FIGS. 23A-23B provide more detailed views of pettier device 160. Between plates 162 and 164, heat directing element 163 is connected to printed circuit 166, which is connected, illustratively by solder or adhesive, to a temperature detector 167, illustratively a resistance temperature detector.

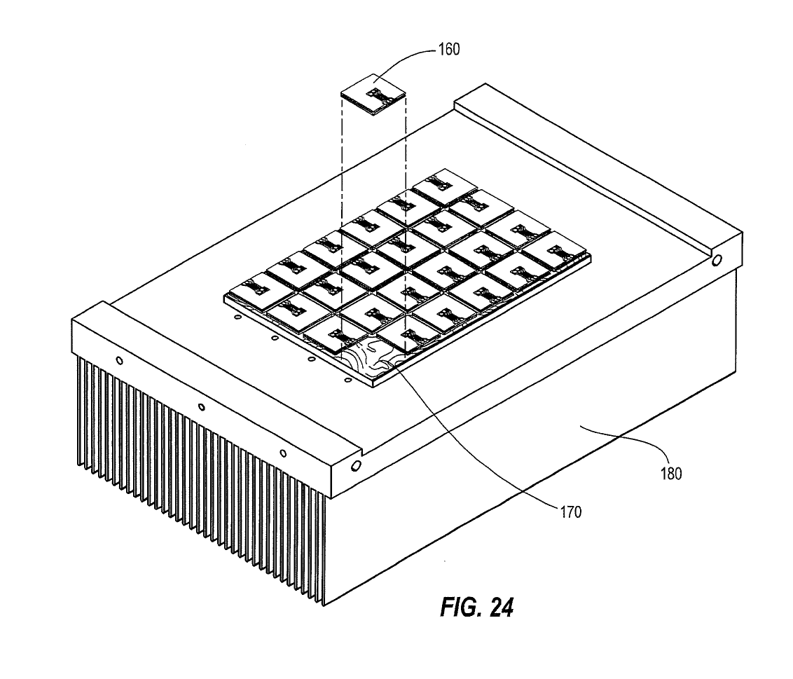

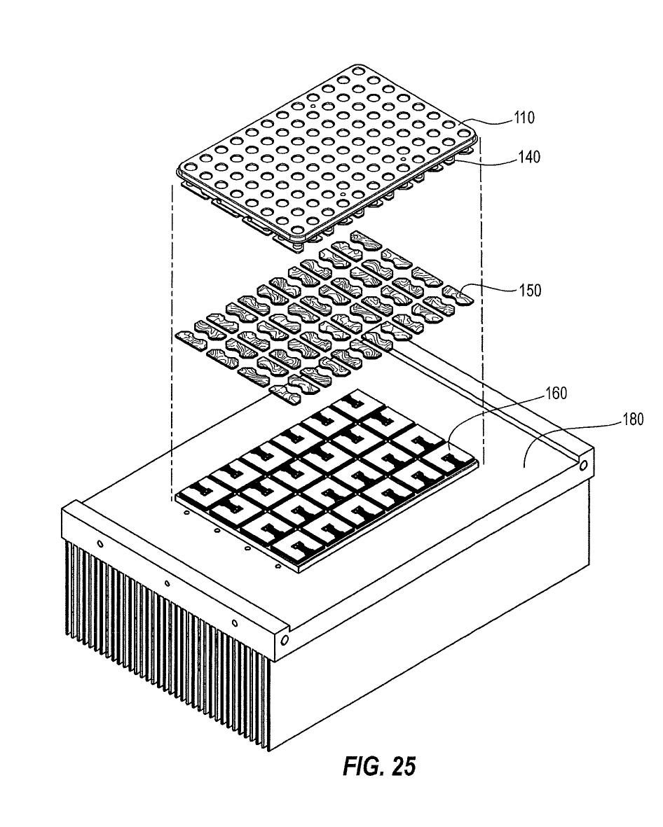

FIGS. 24-25 depict a method of manufacturing apparatus 100. FIG. 24 shows peltier device 160 being placed on adhesive 170. FIG. 25 shows the subsequent steps of placing adhesive 150 on peltiers 160 followed by placement of base plates 140 on adhesive 150. An advantage of this configuration is that clamps or screws such as those described above are not necessary. However, use of such clamps or screws is not precluded with apparatus 100.

As shown in FIGS. 24-25 twenty-four peltiers 160 are used, although it is understood that more or fewer peltiers 160 may be used, depending on the desired application. Illustratively, for a 96-well plate, between 4 and 96 peltiers may be used, with zones of 24 wells if 4 peltiers are used, down to zones of one well, with each pettier controlling an individual well. In one illustrative embodiment, each peltier device 160 is individually driven. Illustratively, the peltiers 160 are not in series nor parallel. Such may be used to provide greater well-to-well uniformity, for example by heating the exterior peltiers to a slightly higher temperature, thus reducing the issue of cooler maximum temperatures in the exterior wells, particularly in the corner wells. Individually driven peltiers 160 also may be used to provide for a temperature gradient across the plate.

FIG. 26 is a perspective view of a series of twenty-four pettier devices 160 on heat sink 180 and their wires that connect pettier devices 160 to a printed circuit. The printed circuit is connected to the temperature detectors 167.

FIG. 27 shows well block 110 on peltier devices shown in FIG. 26 and their associated wires 181. As seen in FIG. 15C, there is a channel 141, which is a space, between each pair of base plates 140, so when well block 110 and base plates 140 are placed on peltier devices 160, the wires extending from peltier devices 160 may extend through this space.

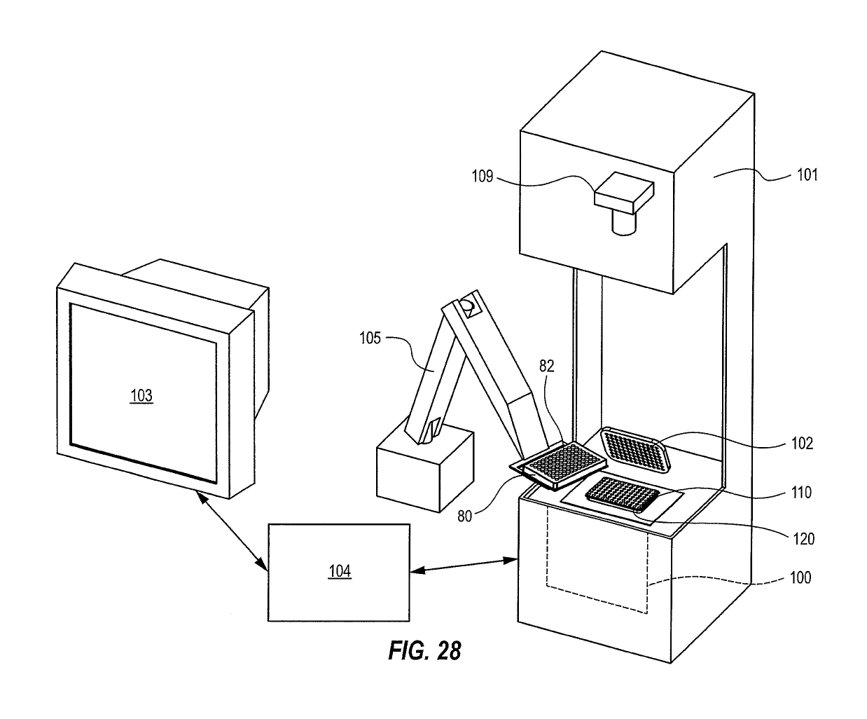

FIG. 28 shows an automated system containing thermal cycler apparatus 100. Thermal cycler apparatus 100 is mounted within a housing 101. Well block 110 is positioned to receive sample plate 80 once sample plate 80 is inserted into opening 102. Opening 102, as shown in FIG. 28 is a movable lid, but it is understood that opening 102 can be any type of opening as are known in the art, including a slot, a door, etc. Optionally, the lid mechanism may close down onto sample plate 80 to seal the sample within sample wells 82 or to force wells 82 of sample plate 80 into better contact with wells 120 of well block 110. If real-time data acquisition or post-PCR melting is desired, an optics block 109 may be provided for sample excitation and detection. Optics block 109 may provide single-color or multi-color detection, as is known in the art.

The system includes a computing device 104, which may comprise one or more processors, memories, computer-readable media, one or more HMI devices 103 (e.g., input-output devices, displays, printers, and the like), one or more communications interfaces (e.g., network interfaces, Universal Serial Bus (USB) interfaces, etc.), and the like. Computing device 104 may be provided within housing 101, or may be provided separately, such as a laptop or desktop computer, or portions of computing device 104 may be resident within housing 101, while other portions are located separately and may be coupled through wiring or wirelessly. Computing device 104 may be configured to load computer-readable program code for controlling thermal cycler apparatus 100 and optics block 109. In one illustrative embodiment, thermal cycler apparatus 100 in housing 101 may be provided in an automated system with a robotics unit 105. The robotics unit 105 may be programmed to load the samples into sample wells 82 and then load sample plate 80 into housing 101 through opening 102. Optionally, robotics unit 105 may also prepare the samples prior to loading into sample wells 82. Teach points may be used by robotics unit 105 for orienting plate 80 into well block 110. Teach points 134a-c are best seen in FIG. 16, where three teach points are used. In this illustrative arrangement, teach point 134a is located near a first edge 177, while teach points 134b and 134c are located near a second edge 178 of well block 110. With three teach points, the robotics unit 105 can easily identify the orientation of well block 110. However, it is understood that three teach points is illustrative and any number of teach points can be used. Control of robotics unit 105 may be through computing device 104, or robotics unit 105 may be controlled by a separate processor. Optionally, robotics unit 105 may be configured to load samples into multiple thermal cycler devices.

It will be understood that reference to PCR is illustrative only and the devices of this disclosure may be compatible with other methods of amplification. Such suitable procedures include strand displacement amplification (SDA); nucleic acid sequence-based amplification (NASBA); cascade rolling circle amplification (CRCA), Q beta replicase mediated amplification; isothermal and chimeric primer-initiated amplification of nucleic acids (ICAN); transcription-mediated amplification (TMA), and the like. Asymmetric PCR may also be used. Therefore, when the term PCR is used herein, it should be understood to include variations on PCR as well as other alternative amplification methods, as well as post-PCR processing, such as melt curve analysis. Illustrative examples of suitable melt curve analysis can be found in U.S. Pat. No. 7,387,887, herein incorporated by reference. Furthermore, the devices of this disclosure may be suitable for a variety of other biological and non-biological reactions that require temperature control.

As peltiers 160 may be individually driven, an illustrative embodiment for determining when each peltier requires calibrating, adjusting, or replacing in order to achieve uniformity among peltiers or to correct for differences between the actual, measured temperature produced by a peltier and the apparatus temperature set point that attained the actual temperature, is provided. Methods for calibrating peltiers may involve adjusting, controlling, or resetting the energy output of each peltier individually to allow for proper and adequate control of sample temperature in wells corresponding to each pettier-controlled temperature zone. Methods for calibrating peltiers may also involve replacing the peltier entirely.

In one illustrative embodiment of the present invention, a calibrator sample plate comprising a plurality of sample wells is provided. Illustratively, as in FIGS. 1-2, a calibrator 96-well plate 80 with sample wells 82, may be positioned on well block 110 of thermal cycler apparatus 100 such that each sample well 82 is positioned in a well 120 of well block 110; a plurality of wells 82 comprising reagents for indicating the temperature of the sample in that well.

It is noted, and one skilled in the art would be aware, that a wide variety of thermal cyclers are known in the art and the embodiment represented in FIGS. 1-2 is illustrative only. Other thermal cycler configurations having one or more temperature zones are within the scope of this invention.

One or more peltiers are then gradually heated to a point beyond the known temperature-indicating range of the reagent. The temperature-indicating reagents in each sample well are monitored by optics block 109 (shown in FIG. 28) to determine the actual, experimental, or approximate temperature of sample in each sample well. Temperature-indicating reagents may also be used to determine the ramp rate or rate of temperature change in each sample well. Additional temperature ranges and temperature-indicating reagents may also be used to determine other actual, experimental, or approximate temperatures for the sample in each sample well. The energy output of each peltier may be adjusted, calibrated, or reset individually to achieve uniformity among temperature zones or to correct for differences between the actual temperature of sample in each sample vessel and the temperature presumed to be achieved by the peltiers.

In one illustrative embodiment, each sample well of a 96-well calibrator plate comprises a calibration mixture comprising one or more nucleic acids that anneal to form at least one intramolecular or intermolecular nucleic acid melting domain, wherein each melting domain melts at a distinct melting temperature (Tm), and a reagent that differentiates between single-stranded and double-stranded nucleic acids. Illustratively, each melting domain may have a Tm within the normal thermal cycling or melting range for PCR or post-PCR melting, or one or more of the melting domains may have a Tm that brackets the thermal cycling or melting range. The calibrator plate is inserted into a thermal cycling apparatus and the peltiers are gradually heated to a point beyond the known melting temperatures for nucleic acid melting domains in the calibration mixture. As the temperature of calibration mixture in each well increases, nucleic acid melting domains in each sample begin to transition from a double-stranded to a single-stranded configuration and the signal from the reagent is monitored by optics to determine the change in relative amounts of single-stranded or double-stranded nucleic acids. Change in signal can be plotted, illustratively on a computer monitor, to generate a melting curve, from which an experimental melting temperature may be calculated. Peltiers are then adjusted, calibrated, or replaced to ensure that the temperatures displayed or recorded by the thermal cycling apparatus during nucleic acid melting or transition is comparable and within acceptable limits, deviation, or error from the known melting temperature of each nucleic acid melting domain.

### Example 1

### Thermal Cycler Calibration Using 96-Well Plate

A thermal cycler apparatus similar to device 180 of FIG. 1 was calibrated to ensure uniformity and the proper control of sample temperature in the sample wells corresponding to each of the twenty-four peltier-controlled temperature zones, each temperature zone comprising a single peltier, which heats four wells. A 96-well sample plate 80 was loaded with calibration mixture in each well, the calibration mixture illustratively comprising two melting domains, each of which may be FRET oligonucleotide probe pairs (such as HybProbes®), two complementary oligonucleotides each labeled with a member of a FRET pair, single-labeled oligonucleotides (such as SimpleProbes®), molecular beacons, and other labeled probe configurations that provide a detectable signal upon melting, as are known in the art. Alternatively, the entities could be unlabeled double-stranded nucleic acid, and the sample may additionally contain a double-stranded DNA binding dye that produces a detectable signal when bound to dsDNA that is different than when not bound to dsDNA. Suitable dyes include SYBR® Green I and LCGreen® Plus. Many other suitable dyes are known in the art. In the illustrative example, two double-stranded oligonucleotides are used, each designed to melt at a different distinct, pre-determined temperature. Thus, two distinct melting peaks should be seen in a melting curve generated from melting this mixture. In the illustrative example, each double-stranded oligonucleotide comprises a pair of complementary nucleic acid strands, one of which is labeled with Oregon Green 514 as an indicator of double-stranded nucleic acid. A low temperature probe has a true Tm of approximately 42° C., while a high temperature probe has a true Tm of approximately 79° C. However, it is understood that other indicators having other Tms may be used.

It is noted, and one skilled in the art would be aware, that a wide variety of other temperature indicators are known in the art and contemplated within the scope of this invention, such as temperature sensitive optical materials that undergo a color change at a specific temperature. It will be appreciated that the goal is to provide a detectable signal at a predetermined known or calculated temperature such that the measured temperature can be compared to the predetermined known or calculated temperature.

Because the illustrative calibrator plate 80 is to be used for instrument calibration, other components for PCR or other amplification methods (e.g. polymerase, dNTPs) need not be provided. Additionally, the plate 80 may be provided with the calibration mixture sealed in each well, thus preventing addition of sample materials and allowing for multiple calibration uses while minimizing risk of spilling the contents. However, it is understood that the calibration mixture may be configured for PCR, in which case the calibration plate would be thermal cycled prior to generation of the calibration melt curve.

The calibrator plate of this illustrative example was placed in the thermal cycler apparatus. A melting program comprising parameters designed specifically to execute a series of steps within the thermal cycler apparatus to melt the double-stranded nucleic acids within an acceptable temperature range was initiated. The signal produced by the Oregon Green dye was monitored throughout the method and calibration process. Upon completion of the melting program, signal data were processed by computer software designed to generate and produce melting curve data and calculate the experimental Tm for each double-stranded oligonucleotide.

It is noted that melting parameters and signal data processing are variable and often specific to the reagents comprising the experiment or calibration procedures. The scope of this invention is not limited to a single or set of melting parameters or signal data processing procedures. However, various melting data processing procedures, including such for high resolution melting, are known in the art and are within the scope of the present invention.

The melting temperatures of one such calibration are shown below in Tables 1-4.

TABLE 1
Low Temperature Before Calibration

| | 1 | 2 | 3 | 4 | 5 | 6 |
|---|---|---|---|---|---|---|
| A | 42.09 | 42.02 | 42.00 | 42.02 | 41.95 | 42.03 |
| B | 42.00 | 41.98 | 41.95 | 41.94 | 41.92 | 42.06 |
| C | 42.43 | 41.89 | 41.89 | 41.81 | 41.87 | 41.89 |
| D | 41.81 | 41.74 | 41.74 | 41.72 | 41.70 | 41.69 |

TABLE 2
High Temperature Before Calibration

| | 1 | 2 | 3 | 4 | 5 | 6 |
|---|---|---|---|---|---|---|
| A | 79.28 | 79.10 | 78.95 | 78.93 | 78.79 | 78.86 |
| B | 78.94 | 78.76 | 78.53 | 78.58 | 78.63 | 78.73 |
| C | 78.32 | 78.29 | 78.23 | 78.12 | 78.16 | 78.17 |
| D | 77.72 | 77.50 | 77.39 | 77.38 | 77.28 | 77.40 |

TABLE 3
Low Temperature After Calibration

| | 1 | 2 | 3 | 4 | 5 | 6 |
|---|---|---|---|---|---|---|
| A | 42.03 | 42.06 | 42.00 | 42.03 | 42.04 | 41.97 |
| B | 42.00 | 42.02 | 42.02 | 42.06 | 42.00 | 41.99 |
| C | 42.01 | 42.01 | 42.04 | 42.06 | 42.00 | 41.99 |
| D | 42.03 | 42.04 | 42.01 | 42.08 | 42.01 | 42.05 |

TABLE 4
High Temperature After Calibration

| | 1 | 2 | 3 | 4 | 5 | 6 |
|---|---|---|---|---|---|---|
| A | 78.76 | 78.75 | 78.77 | 78.75 | 78.76 | 78.78 |
| B | 78.72 | 78.74 | 78.76 | 78.75 | 78.76 | 78.77 |
| C | 78.84 | 78.73 | 78.76 | 78.76 | 78.77 | 78.76 |
| D | 78.73 | 78.77 | 78.75 | 78.76 | 78.75 | 78.75 |

Table 1 shows the average low calibration temperature for each of the 24 temperature zones prior to calibration, wherein the individual temperatures from each well is averaged to produce the zone temperature. In this example, zone C1 is the warmest, with an average temperature of 42.43° C., while zone D6 is the coolest, with an average temperature of 41.69° C. The difference between the warmest and coolest zones is 0.74° C. Table 2 is similar to Table 1, except showing the average high calibration temperature for each of the 24 temperature zones. At the high calibration temperature, zone A1 is the warmest, with an average temperature of 79.28° C., while zone D5 is the coolest, with an average temperature of 77.28° C. The difference between the warmest and coolest zones is 2.00° C. It is noted that different zones were the hottest and coolest for the two different melts.

Discrepancies or differences between the theoretical, known, or pre-determined Tm and the mean experimental Tm may be corrected by adjusting, resetting, or calibrating the output of each peltier to bring the experimental Tm into agreement with the pre-determined Tm, thereby allowing adjustment of each temperature zone to provide a measured temperature output approximately equal to the known temperature output at the pre-determined Tm. Such adjusting, resetting, or calibrating of each peltier used for a temperature zone may include adjusting the value of the electrical input delivered thereto for a desired temperature output, or adjusting the pre-programmed temperature level for a particular value of the electrical input made to the peltier. As such, the correction of each peltier used for a temperature zone against the pre-determined Tm establishes a significant increase in the consistency of the measured temperatures across each sample vessel across the calibrator plate, thereby significantly increasing the consistency of any measured results in subsequent thermal cycling activities.

Because peltiers may vary to a different degree at different voltages, it may be desirable to use multiple predetermined known or calculated Tm's to measure the temperatures when adjusting the setting for each peltier. As discussed above, in the illustrative example, two different double-stranded oligonucleotides are used, generating two distinct Tms, a measured high calibration temperature and a measured low calibration temperature.

For a two-point calibration, for each temperature zone a low calibration temperature and a high calibration temperature are calculated, as follows:

LowCalibrationTemperature=(PreviousLowCalibrationTemperature*A)+B

HighCalibrationTemperature=(PreviousHighCalibrationTemperature*A)+B

Where A and B are:

A=(TrueHighTM−TrueLowTM)/(MeasuredHighTM−MeasuredLowTM)

B=((TrueLowTM*MeasuredHighTM)−(TrueHighTM*MeasuredLowTM))/(MeasuredHighTM−MeasuredLowTM),

and where the TrueHighTM and TrueLowTM are predetermined temperatures, and the Previous LowCalibrationTemperature and PreviousHighCalibrationTemperature were determined in a previous round of calibration. This may have occurred when a service technician or end-user performs a calibration using calibration plate 80, or it may have occurred during initial factory calibration.

A linear adjustment using the LowCalibrationTemperature and the HighCalibrationTemperature is then calculated for each peltier. Because each peltier 160 is controlled independently, the input to each peltier, such as voltage or resistance, is optionally adjusted across the temperature range according to the calculated linear adjustment. Referring back to Tables 1-4 in this exemplary embodiment, after calibration, the difference between the warmest low temperature zone (D4 at 42.08° C.) and the coolest low temperature zone (A6 at 41.97° C.) is only 0.11° C. Similarly, after calibration, the difference between the warmest high temperature zone (C1 at 78.84° C.) and the coolest high temperature zone (B1 at 78.72° C.) is only 0.12° C. It is noted that both before and after calibration in the melts represented in Tables 1-4, different zones had the warmest melt at the low and high temperatures, and different zones had the coolest melt at both the high and low calibration temperatures, thus demonstrating that each individual temperature zone is adjusted based on its own linear adjustment across temperatures. If a single calibration melt had been used for each zone, the extent of calibration needed at the other end of the melt range would have been missed, resulting in a better adjustment at the measured calibration temperature and potentially decreasing the calibration at the other end of the temperature range. Calibration may be repeated, if desired, and may be done in an iterative process, until sufficient temperature uniformity is achieved. If sufficient uniformity cannot be achieved, such failure may be due to one or more peltiers that are failing to perform satisfactorily. If a particular temperature zone continually provides results that are not sufficiently uniform (either run-to-run uniformity or uniformity between temperature zones), it may be desirable to replace the peltier for that temperature zone. It is understood that ultimate block uniformity may be limited by the worst performing peltier.

It is understood that the instrument, either internally or through an external computing device 104, may be programmed to initiate calibration subsequent to the generation of the melt curves. Alternatively, the calibration may be performed manually using the true and experimental Tms.

While 2 calibration temperatures are used in this illustrative example, it is understood that other numbers of calibration temperatures may be used, such as 3, 4, 5, or n calibration temperatures. Furthermore, while the illustrative adjustment is linear across the temperature range, depending on the heat source used, it is understood that the adjustment may be non-linear (e.g. exponential), or may be a best fit curve if more than two calibration temperatures are used. Also, while the illustrative example provides calibration for 24 temperature zones, it is understood that the methods described herein can be used for adjusting the heat source for any number of temperature zones, depending on the configuration of the instrument, including an instrument having one temperature zone. It is also understood that the calibration methods described herein may be used in combination with software that adjusts melt curve data subsequent to melting, as is known in the art.

It will be understood by those having skill in the art that changes may be made to the details of the above-described embodiments without departing from the underlying principles presented herein. For example, any suitable combination of various embodiments, or the features thereof, is contemplated.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, inventive aspects lie in a combination of fewer than all features of any single foregoing disclosed embodiment. It will be apparent to those having skill in the art that changes may be made to the details of the above-described embodiments without departing from the underlying principles set forth herein.

The claims following this Detailed Description are hereby expressly incorporated into this Detailed Description, with each claim standing on its own as a separate embodiment. This disclosure includes all permutations of the independent claims with their dependent claims. Recitation in the claims of the term “first” with respect to a feature or element does not necessarily imply the existence of a second or additional such feature or element. Embodiments of the invention in which an exclusive property or privilege is claimed are defined as follows.

1. A method for calibrating a thermal cycling apparatus having at least one heat source, comprising the steps of:
providing a container comprising at least one sample vessel, wherein vessel comprises a calibration mixture comprising nucleic acids having at least one nucleic acid melting domain, the melting domain having a predetermined temperature, and a reagent that produces a signal to differentiate between single-stranded and double-stranded nucleic acids,
introducing the container into the thermal cycling apparatus,
heating the contents of the container,
monitoring the reagent to calculate a measured melting temperature, and
adjusting the heat source to correct discrepancies between the predetermined melting temperature and the measured melting temperature of melting domains.

2. The method of claim 1 wherein the reagent is a dsDNA binding dye.

3. The method of claim 1 wherein the reagent is a fluorescent dye that is bound to one of the nucleic acids.

4. The method of claim 1 wherein the container is a sample plate, the sample vessels are sample wells, and each well contains the calibration mixture.

5. The method of claim 4 wherein the calibration mixture comprises a second melting domain, the second melting domain having a predetermined temperature that is different from the predetermined temperature of the melting domain, and both melting domains are used in the adjusting step.

6. The method of claim 5 wherein the melting domain is a low temperature melting domain, the second melting domain is a high temperature melting domain, and the adjustment is an adjustment across temperatures using a LowCalibrationTemperature point and HighCalibrationTemperature point, wherein the two points are calculated as follows:
LowCalibrationTemperature=(PreviousLowCalibrationTemperature*A)+B
HighCalibrationTemperature=(PreviousHighCalibrationTemperature*A)+B
where A and B are:
A=(TrueHighTM−TrueLowTM)/(MeasuredHighTM−MeasuredLowTM)
B=((TrueLowTM*MeasuredHighTM)−(TrueHighTM*MeasuredLowTM))/(MeasuredHighTM−MeasuredLowTM), and
where the TrueHighTM and TrueLowTM are predetermined temperatures, and PreviousLowCalibrationTemperature and PreviousHighCalibrationTemperature were determined in a previous round of calibration.

7. The method of claim 6 wherein the adjustment across temperatures is a linear adjustment across temperatures.

8. The method of claim 5 wherein
the thermal cycling apparatus has a plurality of heat sources, each heat source corresponding to a temperature zone comprising at least one sample well,
a measured melting temperature is generated for the low temperature melting domain and the high temperature melting domain for each heat source, and
a separate adjustment is made for each heat source.

9. The method of claim 1 wherein the calibration mixture does not contain sufficient components for amplification and the sample vessel is provided sealed to prevent addition of components for amplification.

10. A device for use in calibrating a thermal cycling apparatus, comprising:
a container comprising a plurality of sample vessels, each sample vessel comprising a calibration mixture comprising nucleic acids having at least one nucleic acid melting domain, the melting domain having a predetermined temperature, and a reagent that produces a signal to differentiate between single-stranded and double-stranded nucleic acids and configured to generate a measured temperature for the melting domain, wherein the calibration mixture does not contain sufficient components for amplification and the sample vessel is provided sealed to prevent addition of components for amplification

11. The device of claim 10 wherein the nucleic acids comprise a second nucleic acid melting domain.

12. A method for calibrating a thermal cycling apparatus having at least one heat source, comprising the steps of:
providing a container comprising at least one sample vessel, wherein vessel comprises a calibration mixture comprising temperature-indicating reagent that provides a measurable signal a temperature, the reagent having a predetermined temperature,
introducing the container into the thermal cycling apparatus,
heating the contents of the container,
monitoring the reagent to calculate a measured temperature, and
adjusting the heat source to correct discrepancies between the predetermined temperature and the measured temperature.

13. A system for calibration comprising:
a container comprising at least one sample vessel, wherein vessel comprises a calibration mixture comprising nucleic acids having at least one nucleic acid melting domain, the melting domain having a predetermined temperature, and a reagent that is configured to produce a measured melting temperature of the calibration mixture,
a thermal cycler system comprising
at least one heat source, and
computing device configured to calculate desired adjustment of heat output from the heat source using the predetermined temperature and the measured temperature.

14. The system of claim 13 wherein
the thermal cycler comprises a plurality of heat sources, each heat source configured to be controlled independently of the other heat sources,
the container comprises at least one sample vessel corresponding to each heat source, and
the computing device is configured to calculate desired adjustment for each individual heat source.

15. The system of claim 14 wherein the heat sources are peltiers.
